(19) United States
(12) Patent Application Publication
(10) Pub. No.: US 2005/0100191 A1
(43) Pub. Date: May 12, 2005

(54) Imaging system and method for monitoring an eye

(76) Inventors: Andrew P. Harbach, Kokomo, IN (US); Gregory K. Scharenbroch, Kokomo, IN (US); Gerald J. Witt, Carmel, IN (US); Timothy J. Newman, Noblesville, IN (US); Nancy G. Edenborough, Noblesville, IN (US); Riad I. Hammoud, Kokomo, IN (US)

Correspondence Address: STEFAN V.CHMIELEWSKI;DELPHI TECHNOLOGIES, INC., Legal Staff MC CT10C, P.O.Box 9005, Kokomo, IN, 46904-9005, US

(21) Appl. No.: 10/705,541

(22) Filed: Nov. 11, 2003

(51) Int. Cl. G06K 9/00

(52) U.S. Cl. 382/103; 382/104; 382/117

(57) ABSTRACT

A system and method are provided for monitoring an eye. The system includes a video imaging camera oriented to generate images of an eye. The camera is aligned along an imaging axis. A first light source is located at an angle less than 2.5 degrees of the imaging axis for illuminating the eye. A second light source is arranged at an angle greater than 4.5 degrees from the imaging axis for illuminating the eye. The system includes a processor for processing the images generated with the video imaging camera during illumination of the eye with the first light source and during illumination of the eye with the second light source.

### TECHNICAL FIELD

The present invention generally relates to eye monitoring and, more particularly, relates to monitoring an eye, such as one or both eyes of a driver of a vehicle, with a light illuminated video imaging system.

### BACKGROUND OF THE INVENTION

Video imaging systems have been proposed for use in vehicles to monitor the driver and/or passengers in the vehicle. Some proposed video imaging systems include one or two cameras focused on the driver of the vehicle to capture images of the driver's face and allow for determination of various facial characteristics of the driver including the position, orientation, and movement of the driver's eyes, face, and head. By knowing the driver facial characteristics, such as the driver's eye position and gaze, vehicle control systems can provide enhanced vehicle functions.

A vehicle control system can monitor one or both eyes of the driver and determine a condition in which the driver appears to be drowsy, and can take further action to alert the driver of the driver drowsy condition. The vehicle control system can also determine if the driver is distracted, and take action to minimize the distraction. Further, the vehicle control system can monitor the driver eye gaze and control various vehicle systems, such as the radio and entertainment system, and provide enhanced control of such systems.

Some proposed vision-based imaging systems that monitor the eye(s) of the driver of a vehicle require infrared (IR) illumination along with visible light filters to control scene brightness levels inside of the vehicle cockpit. The ability to discern facial characteristics is a considerable requirement in the case of driver monitoring. Current techniques for illuminating the driver's face with infrared illumination include providing a light source focused on the driver's eye(s). Other techniques for illuminating the driver's face propose employing multiple light sources of different wavelengths, arranged in a generally concentric ring, for generating a bright eye pupil and dark eye pupil effect.

Some proposed eye monitoring techniques process video images taken during both the bright eye pupil and dark eye pupil illuminations, and process the difference in the acquired bright and dark eye pupil images. By taking the difference in images acquired during bright and dark illumination, glare and other undesirable effects caused by bright images can be removed to allow for enhanced identification of the target eye. While combined dark and bright eye pupil illuminations have been proposed, such techniques typically require a large number of light sources of multiple wavelengths arranged in the shape of a concentric ring adjacent to and surrounding the video imaging camera.

It is therefore desirable to provide for an effective method for illuminating an eye and generating images of the eye to allow for enhanced eye monitoring of a person in the vehicle. In particular, it is desirable to provide for a more cost affordable system that offers flexible packaging of the light source illuminators and is easy and economical to manufacture.

### SUMMARY OF THE INVENTION

In accordance with the teachings of the present invention, a system and method are provided for monitoring an eye. According to one aspect of the present invention, the system includes a video imaging camera oriented to generate images of an eye. The camera is aligned along an imaging axis. A first light source is located at an angle less than 2.5 degrees from the imaging axis for illuminating the eye. A second light source is arranged at an angle greater than 4.5 degrees from the imaging axis for illuminating the eye. The video imaging camera acquires a first image when the first light source illuminates the eye, and generates a second image when the second light source illuminates the eye. The system further includes a processor for processing the first image and the second image.

According to another aspect of the present invention, the method includes arranging a video imaging camera oriented along an imaging axis to generate images of an eye. The method also includes arranging a first light source at an angle less than 2.5 degrees from the imaging axis, and a second light source at an angle greater than 4.5 degrees from the imaging axis. The method also includes the steps of illuminating an eye with the first light source, and generating a first image of the eye while the eye is illuminated with the first light source. The method further includes the steps of illuminating the eye with the second light source, and generating a second image of the eye while the eye is illuminated with the second light source. Further, the method includes processing the first and second images.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is a top view of an eye monitoring system having video imaging camera located in the cockpit of a vehicle and projecting towards the eyes of a driver;

FIG. 2 is a side elevational view of the projection of the eye monitoring system towards the eye of the driver;

FIG. 3 is a front view of the eye monitoring system focused on an eye of the driver;

FIG. 4 is a block diagram illustrating the eye monitoring system;

FIG. 5 illustrates the acquisition of a video image of the eye shown with bright illumination of the eye pupil;

FIG. 6 illustrates the acquisition of a video image of the eye shown with dark illumination of the eye pupil;

FIG. 7 is a flow diagram illustrating a routine for controlling the illumination and acquisition of images with the eye monitoring system; and

FIG. 8 is a flow diagram illustrating a method of applying the eye monitoring system for use in exemplary vehicle applications.

### DESCRIPTION OF THE PREFERRED EMBODIMENT

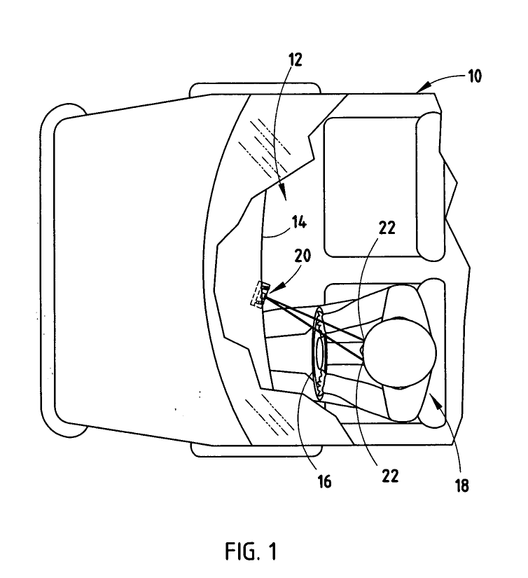

Referring now to FIG. 1, the passenger compartment (cockpit) 12 of a vehicle 10 is generally shown equipped with a mono-camera driver eye monitoring system 20. The eye monitoring system 20 has a video imaging camera and first and second light illumination sources located within the dash 14 and focused on the person (driver) 18 driving the vehicle 10 for illuminating the face of the driver 18 and generating images of the driver 18.

The eye monitoring system 20 is shown mounted generally in a mid-region of the dash 14 in the front region of the vehicle cockpit 12. The eye monitoring system 20 may be mounted in any of a number of various locations within the vehicle 10 which allow for light illumination and acquisition of video images of one or both eyes of the driver 18 of the vehicle 10. For example, the video imaging camera 20 may be mounted in the steering assembly 16, or mounted elsewhere in the dash 14, or may be mounted in the instrument cluster. While the eye monitoring system 20 is shown and described herein in connection with a single video imaging camera, it should be appreciated that two or more video imaging cameras may be employed, without departing from the teachings of the present invention.

The eye monitoring system 20 is mounted to the dash 14 such that the light illumination sources illuminate the eye(s) of the driver and the video imaging camera captures successive video image frames of the region where the driver 18 of the vehicle 10 is expected to be located during normal vehicle driving. More particularly, the video image captures the driver's face including one or both eyes 22 and the surrounding ocular features generally formed in the area referred to as the ocular adnexa. The acquired video images are then processed for tracking characteristics of one or both eyes 22 of the driver 18. Each video frame image may be processed to determine whether one or both eyes 22 of the driver 18 are in an open position or a closed position to determine a driver drowsiness condition. The video frame images may be processed to determine a driver distraction condition, an inattentive driver, or other conditions.

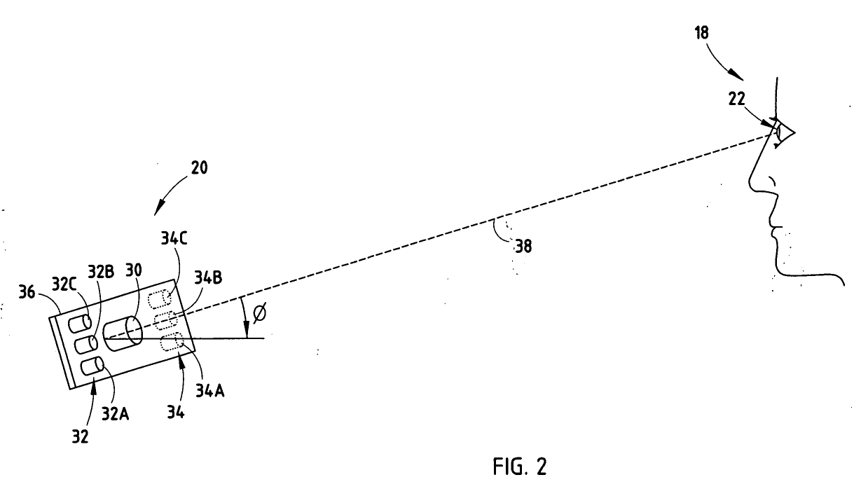

Referring to FIG. 2, the eye monitoring system 20 is shown having a housing 36 and a video imaging camera 30 mounted to the housing 36 and focused on an eye 22 of the driver 18. The video imaging camera 30 is shown focused along an imaging axis 38 at an inclination angle φ relative to the horizontal plane of the vehicle 10. The inclination angle φ is within the range of zero to thirty degrees (0° to 30°). An inclination angle φ in the range of zero to thirty degrees (0° to 30°) generally provides a clear view of the driver's ocular features including one or both eyes 22 and the pupil of the eyes 22, the superior and inferior eyelids, and the palpebral fissure space between the eyelids.

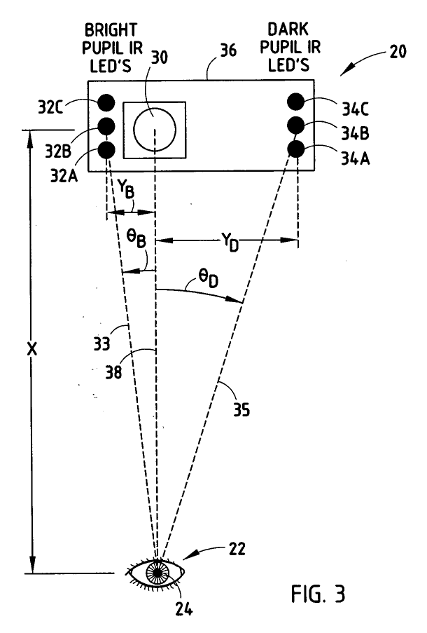

As shown in FIGS. 2 and 3, the eye monitoring system 20 also includes a first light illumination source 32 shown as a first plurality of infrared (IR) light emitting diodes (LEDs) 32A, 32B, and 32C. The eye monitoring system 20 further includes a second light illumination source 34 shown as a second plurality of infrared light emitting diodes 34A, 34B, and 34C. The LEDs 32A-32C and 34A-34C are mounted to housing 36 and are spaced on opposite sides of video imaging camera 30, according to the embodiment shown. Alternately, the LEDs 32A-32C and 34A-34C could be arranged on the same side of camera 30.

The video imaging camera 30 is focused on one or both eyes 22 of the driver of the vehicle. In the embodiment shown, video imaging camera 30 is focused on one eye 22. The video imaging camera 30 is aligned along an imaging axis 38, which generally defines a centerline of the focus of the camera 30 onto the eye 22. Line 33 defines the centerline between the first light illumination source 32 and the eye 22, while line 35 defines the centerline between the second light illumination source 34 and the eye 22.

The eye monitoring system 20 employs the first and second light illumination sources 32 and 34 for illuminating the target eye 22, such that the video imaging camera 30 is able to capture images of the eye 22 and its pupil in bright and dark illuminated conditions. The first plurality of IR LEDs 32A-32C of light source 32 are shown configured in a straight line to one side of the video imaging camera 30. The first plurality of IR LEDs 32A-32C are mounted close to the video imaging camera 30 such that the centerline 33 of first light source 32 is at an angle θ_{B} less than 2.5 degrees from the imaging axis 38. According to another embodiment, the first light source 32 is arranged at an angle θ_{B} less than 2.3 degrees from the imaging axis 38. By arranging the first light source 32 at angle θ_{B} less than 2.5 degrees from the imaging axis 38, the first light source 32 is substantially coaxial with the imaging axis 38 such that the resultant light illumination produces a bright eye image.

The second plurality of IR LEDs 34A-34C of light source 34 are shown configured in a straight line on the opposite side of the video imaging camera 30. The second plurality of IR LEDs 34A-34C are mounted close to the video imaging camera 30 such that the centerline 35 of the second light source 34 is at an angle θ_{D} greater than 4.5 degrees from the imaging axis 38. According to a further embodiment, the second light source 34 is arranged at an angle θ_{D} greater than 4.6 degrees from the imaging axis 38. By arranging the second light source 34 at angle θ_{D} greater than 4.5 degrees from the imaging axis 38, the second light source 34 is substantially non-coaxial with the imaging axis 38 such that the resultant light illumination produces a dark eye image.

The first and second light sources 32 and 34 may include any of a number of commercially available lighting sources. In one embodiment, the light sources 32 and 34 each generate a light source at substantially the same frequency. While each of the first and second light sources 32 and 34 are shown made up of three LEDs, it should be appreciated that any of a number of one or more light lighting devices may be employed for each of light sources 32 and 34, without departing from the teachings of the present invention.

In the example shown, the first plurality of IR LEDs 32A-32C are spaced at a distance of less than twenty-five millimeters (25 mm) from the center of the video imaging camera 30. In this example, the second plurality of IR LEDs 34A-34C are located at a distance YD greater than fifty millimeters (50 mm) from the video imaging camera 30. The video imaging camera 30 light source 32 and 34 are displaced from the eye 22 by a distance X of about six hundred fifteen millimeters (615 mm) according to this example.

The first and second light sources 32 and 34 are illuminated such that only one of the first and second light sources 32 and 34 is on at a time, according to one embodiment. The first plurality of LEDs 32A-32C of first light source 32 are turned on to illuminate the eye 22 to enable the video imaging camera 30 to capture a bright first image of the eye 22. With the first plurality of LEDs 32A-32C turned off, the second plurality of LEDs 34A-34C of light source 34 are then turned on to illuminate the eye 22 so as to allow the video imaging camera 30 to generate a dark second image of the eye 22. The first and second video images captured during bright and dark images of the eye are then processed to discern information about the eye 22 and/or condition of the driver 18.

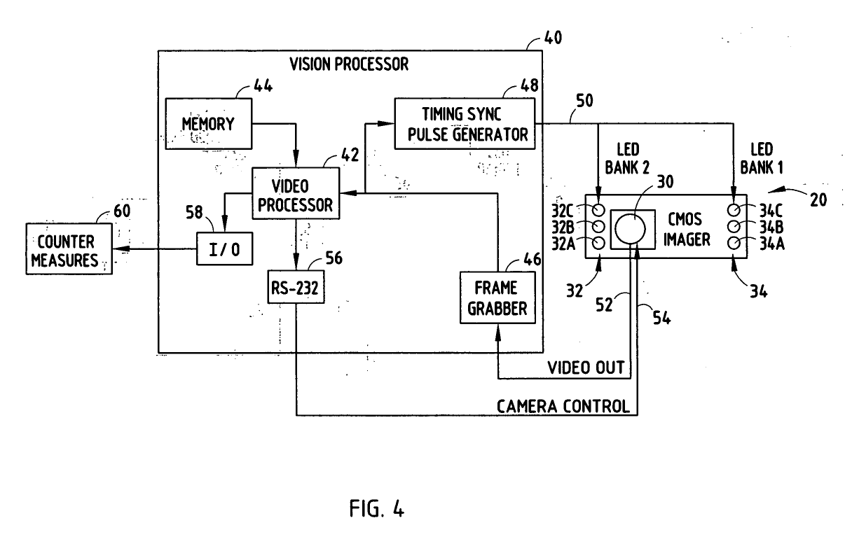

Referring to FIG. 4, the eye monitoring system 20 is further shown having the video imaging camera 30 and first and second light sources 32 and 34 coupled to a vision processor 40 which, in turn, is coupled to countermeasure systems 60 via input/output (I/O) 58. The video imaging camera 30 may include a CCD/CMOS active-pixel digital image sensor mounted as a chip onto a circuit board. One example of a CMOS active-pixel digital image sensor is Model No. PB-0330, commercially available from Photobit, which has a resolution of 640 H×480 V. It should be appreciated that other cameras may be employed.

The vision processor 40 is shown having a frame grabber 46 for receiving the video output frames on line 52 generated by the video imaging camera 30. Vision processor 40 also includes a video processor 42 for processing the acquired video frames. The vision processor 40 includes memory 44, such as random access memory (RAM), read-only memory (ROM), and other memory as should be readily apparent to those skilled in the art. The vision processor 40 may be configured to perform one or more routines for controlling the actuation of first and second light illumination sources 32 and 34, controlling the video imaging camera 30, processing the acquired video images, and applying the processed information to vehicle control systems.

The vision processor 40 has a camera control function via control RS-232 logic 56 which allows for control of the video imaging camera 30 via camera control signals on line 54. Control of the video imaging camera 30 may include automatic adjustment of the pointing orientation of the video imaging camera 30. For example, the video imaging camera 30 may be repositioned to focus on an identifiable feature, and may scan a region in search of an identifiable feature, including the driver's face and, more particularly, one or both eyes 22. Control may also include adjustment of focus and magnification as may be necessary to track an identifiable feature. Thus, the eye monitoring system 20 may automatically locate and track an identifiable feature, such as one or both of the driver's eyes 22.

The vision processor 40 further includes a timing sync pulse generator 48 coupled to video processor 42. The timing sync pulse generator 48 produces timing sync output signals on line 50 to control the activation of the first and second light illumination sources 32 and 34. That is, the timing sync output signals control activation of light sources 32 and 34 by sequentially turning light sources 32 and 34 on and off, so that only one light source is on at a time. The vision processor 40 monitors the timing sync output signals and processes the video output signals as images that were acquired either with the first lighting source 32 or second lighting source 34.

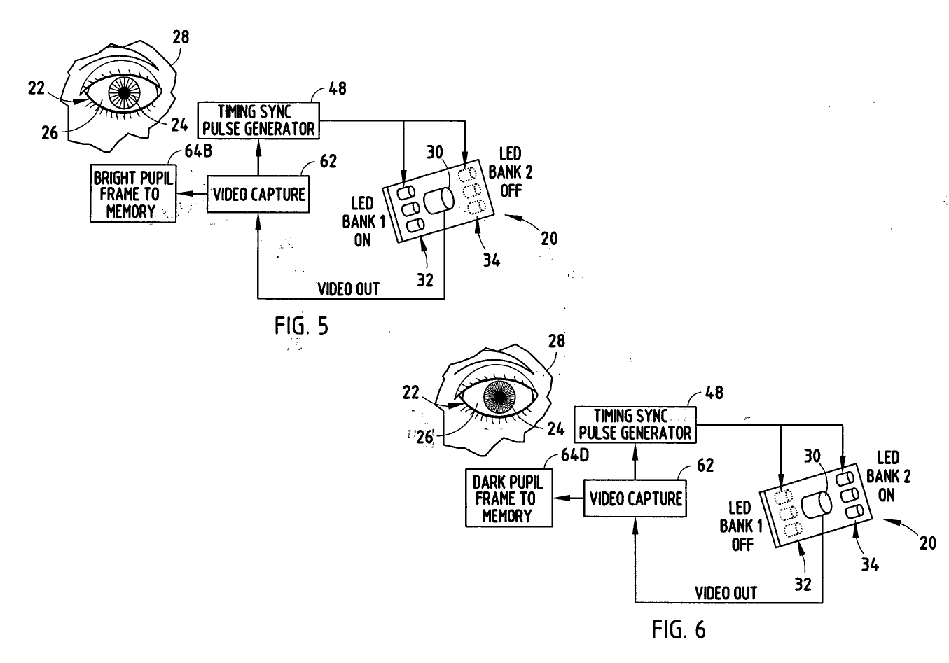

Referring to FIGS. 5 and 6, acquired first and second images of the eye 22 are shown for both bright eye pupil and dark eye pupil illuminations. In FIG. 5, the first light source 32 is turned on, while the second light source 34 is turned off, to generate the bright eye pupil image shown. The timing sync pulse generator 48 controls the light illumination timing, while the bright video captures 62 are stored in memory frame 64B. The resulting coaxial illumination of the eye 22 causes a bright eye pupil effect, such that the iris 24 and its pupil are captured as bright images. The bright pupil reflection is a result of the physiological properties of the human eye. The IR illumination is reflected out through the pupil from the retina and visible at the centerline of the camera.

In FIG. 6, the second light source 34 is turned on, while the first light source 32 is turned off, to generate the dark eye pupil image shown. The dark video captures 62 are stored in memory frame 64D. The resulting non-coaxial illumination of the eye 22 causes a dark eye pupil effect, such that the iris 24 and its pupil are captured as dark images. The dark pupil reflection is a result of the physiological properties of the human eye. The IR illumination is reflected back into the eye away from the retina and is not visible at the centerline of the camera.

The captured bright and dark video images of eye 22 may be processed to determine whether the eye 22 is in an open or closed position, indicative of a drowsy driver condition, or may be evaluated to determine if the driver is inattentive or distracted. This can be achieved by monitoring the sclera 26 and/or the iris 24 of the eye 22 and determining when at least one of the sclera 26 and iris 24 are not visible in the video image due to complete covering of the eyelid to determine a driver drowsiness condition. Driver inattention or distraction can be determined by monitoring the position of the iris 24, as well as positioning of the surrounding facial characteristics.

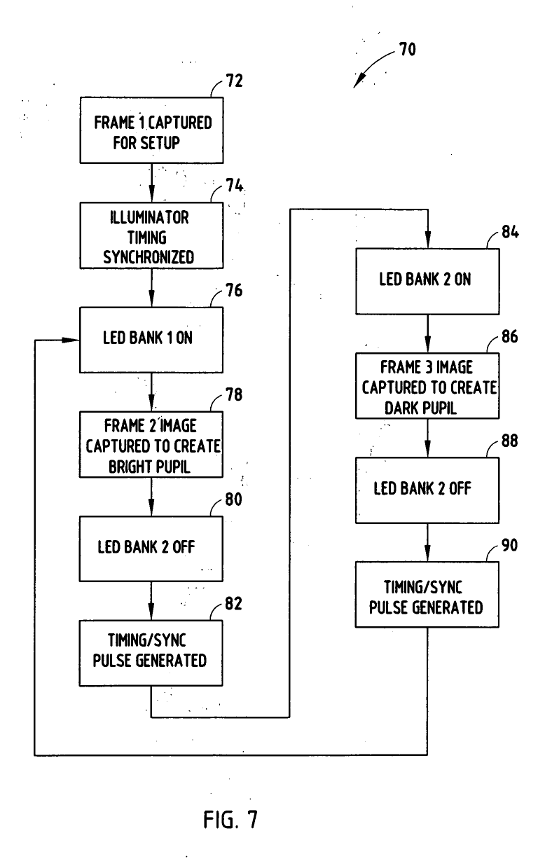

Referring to FIG. 7, a control routine 70 is illustrated for controlling the first and second light illumination sources 32 and 34 and video imaging camera 30 of the eye monitoring system 20. In step 72, routine 70 captures frame 1 for setup. Routine 70 then proceeds to step 74 to synchronize the illuminator timing, and then turns on the LED bank 1 (32A-32C) of the first light source 32 in step 76.

With the first light source 32 turned on, routine 70 captures a frame 2 image to create a bright pupil effect image in step 78. In step 80, the LED bank 2 (34A-34C) of the second light 34 source is turned off in step 80. In step 82, routine 70 generates a timing/sync pulse. Next, in step 84, the LED bank two of the second light source 34 is turned on in step 84. With the second light source 34 turned on, routine 70 captures a frame 3 image to create the dark pupil effect image in step 86. Next, in step 88, routine 70 turns the LED bank 2 of the second light source 34 off in step 88, and then generates a timing/sync pulse in step 90, before returning to step 76. Accordingly, control routine 70 controls the timing for activating the first and second light sources 32 and 34 and capturing images generated during illumination of the first source 32 and then the second light source 34.

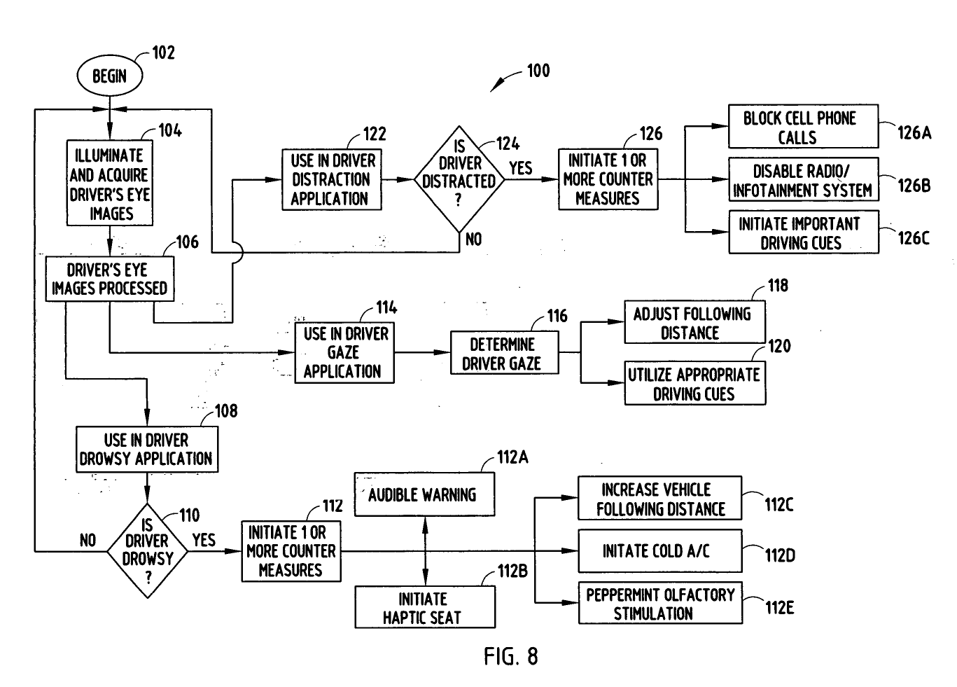

Referring to FIG. 8, a routine 100 is illustrated for applying the eye monitoring system 20 of the present invention in any one or more of various vehicle applications. Routine 100 begins at step 102 and proceeds to illuminate and acquire the driver's eye images in step 104. The driver's eye images are then processed in step 106, according to the present invention. The processed eye images may then be used in step 122 in a driver distraction application in which routine 100 checks whether a driver is distracted in step 124. If the driver is determined to be distracted, routine 100 may initiate one or more countermeasures in step 126. The countermeasures may include blocking cell phone calls in step 126A, disabling a radio/infotainment system in step 126B, and/or initiating important driving cues in step 126C.

The processed eye images may also be used in a driver gaze application as shown in step 114. In the driver gaze application, routine 100 determines a driver gaze in step 116. The determined driver gaze may be employed to adjust the following distance of the vehicle in step 118 and/or utilize appropriate driving cues in step 120.

The processed eye images may further be used in a driver drowsy application as shown in step 108. In the driver drowsy application, routine 100 determines if the driver is drowsy in decision step 110. If the driver is determined to be drowsy, routine 100 initiates one or more countermeasures in step 112. These countermeasures may include an audible warning in step 112A, initiating a haptic seat in step 112B, increasing vehicle following distance in step 112C, initiating cold air conditioning (A/C) in step 112D, and/or activating peppermint olfactory stimulation in step 112E.

Accordingly, the eye monitoring system 20 of the present invention advantageously illuminates and acquires bright and dark images of the eye to allow for easy monitoring of the driver of the vehicle. The eye monitoring system 20 of the present invention is economical and easy to manufacture in a single package, and easy to deploy in a vehicle. It should be appreciated that the eye monitoring systems may be employed in various applications employed both on and off a vehicle.

It will be understood by those who practice the invention and those skilled in the art, that various modifications and improvements may be made to the invention without departing from the spirit of the disclosed concept. The scope of protection afforded is to be determined by the claims and by the breadth of interpretation allowed by law.

1. A system for monitoring an eye, said system comprising:
a video imaging camera oriented to generate images of an eye, wherein the camera is aligned along an imaging axis;
a first light source located at an angle less than 2.5 degrees from the imaging axis for illuminating the eye;
a second light source arranged at an angle greater than 4.5 degrees from the imaging axis for illuminating the eye; and
a processor for processing the images generated with the video imaging camera during illumination of the eye with the first light source, and during illumination of the eye with the second light source.

2. The system as defined in claim 1, wherein the first light source comprises a first plurality of light emitting diodes arranged substantially in a line.

3. The system as defined in claim 2, wherein the second light source comprises a second plurality of light emitting diodes arranged substantially in a line.

4. The system as defined in claim 1, wherein the first light source is substantially coaxial with the video imaging camera such that the first image captures a bright eye pupil effect, and the second light source is substantially non-coaxial with the video imaging camera such that the second image captures a dark eye pupil effect.

5. The system as defined in claim 1, wherein the video imaging camera generates a first image of the eye when the first light source is illuminated, and subsequently generates a second image of the eye when the second light source is illuminated so as to obtain dark and bright images of a pupil of the eye.

6. The system as defined in claim 1, wherein the processor controls the first and second light sources to turn at least one of the first and second light sources on and off.

7. The system as defined in claim 1, wherein the video imaging camera comprises a CMOS imager.

8. The system as defined in claim 1, wherein the first light source is arranged at an angle less than 2.3 degrees from the imaging axis, and the second light source is arranged at an angle greater than 4.6 degrees from the imaging axis.

9. The system as defined in claim 1, wherein the system is employed in a vehicle for monitoring the eye of a driver of the vehicle.

10. The system as defined in claim 1, wherein the first light source and second light source generate light illumination at substantially the same frequency.

11. A vehicle eye monitoring system for monitoring an eye of a person in a vehicle, said system comprising:
a video imaging camera located on a vehicle and oriented to generate images of an eye of a person in the vehicle, wherein the camera is aligned along an imaging axis;
a first light source located on the vehicle and arranged at an angle less than 2.5 degrees from the imaging axis for illuminating the eye;
a second light source located on the vehicle and arranged at an angle greater than 4.5 degrees from the imaging axis for illuminating the eye; and
a processor for processing the images generated with the video imaging camera during illumination of the eye with the first light source, and during illumination of the eye with the second light source.

12. The system as defined in claim 11, wherein the first light source comprises a first plurality of light emitting diodes arranged substantially in a line.

13. The system as defined in claim 12, wherein the second light source comprises a second plurality of light emitting diodes arranged substantially in a line.

14. The system as defined in claim 11, wherein the first light source is substantially coaxial with the video imaging camera such that the first image captures a bright eye pupil effect, and the second light source is substantially non-coaxial with the video imaging camera such that the second image captures a dark eye pupil effect.

15. The system as defined in claim 11, wherein the video imaging camera generates a first image of the eye when the first light source is illuminated, and subsequently generates a second image of the eye when the second light source is illuminated so as to obtain dark and bright images of a pupil of the eye.

16. The system as defined in claim 11, wherein the processor controls the first and second light sources to turn at least one of the first and second light sources on and off.

17. The system as defined in claim 11, wherein the video imaging camera comprises a CMOS imager.

18. The system as defined in claim 11, wherein the first light source is arranged at an angle less than 2.3 degrees from the imaging axis, and the second light source is arranged at an angle greater than 4.6 degrees from the imaging axis.

19. The system as defined in claim 11, wherein the first light source and second light source generate light illumination at substantially the same frequency.

20. A method for monitoring an eye, said method comprising the steps of:
arranging a video imaging camera oriented along an imaging axis to generate images of an eye;
arranging a first light source at an angle less than 2.5 degrees from the imaging axis;
arranging a second light source at an angle greater than 4.5 degrees from the imaging axis;
illuminating an eye with the first light source;
generating a first image of the eye while the eye is illuminated with the first light source;
illuminating the eye with the second light source;
generating a second image of the eye while the eye is illuminated with the second light source; and
processing the first and second images.

21. The method as defined in claim 20 further comprising the step of turning off the first light source when the second light source is illuminated, and turning off the second light source when the first light source is illuminated.

22. The method as defined in claim 20, wherein the step of arranging the video imaging camera, first light source, and second light source comprises arranging a first row of light emitting diodes as the first light source, and arranging a second row of light emitting diodes as the second light source.

23. The method as defined in claim 20, wherein the method is employed for monitoring the eye of a driver of an automotive vehicle.

24. The method as defined in claim 20, wherein the first light source and second light source generate light illumination at substantially the same frequency.
